(19) United States
(12) Patent Application Publication
(10) Pub. No.: US 2007/0204631 A1
(43) Pub. Date: Sep. 6, 2007

(54) Liquefied Chemical Gas Delivery System

(75) Inventors: Richard J. Udischas, Joliet, IL (US); Hwa-Chi Wang, West Chester, PA (US)

Correspondence Address: AIR LIQUIDE;Intellectual Property, 2700 POST OAK BOULEVARD, SUITE 1800, HOUSTON, TX, 77056, US

(73) Assignee: American Air Liquide, Inc., Houston, TX (US)

(21) Appl. No.: 11/462,270

(22) Filed: Aug. 3, 2006

Related U.S. Application Data
(60) Provisional application No. 60/779,207, filed on Mar. 3, 2006.

(51) Int. Cl. F17C 9/02

(52) U.S. Cl. 62/50.2

(57) ABSTRACT

Disclosed herein is an apparatus for providing a chemical gas comprising a fabrication plant, a first vessel having a volume and proximate to the fabrication plant, the first vessel adapted to receive a liquefied chemical gas and to communicate a vaporized chemical gas to the fabrication plant, a source container located at a distance from the fabrication plant, the source container having a volume and adapted to communicate a liquefied chemical gas to the first vessel, and wherein the source container volume is substantially larger than the first vessel volume. Other embodiments and methods are described herein.

### CROSS-REFERENCE TO RELATED APPLICATIONS

The preset application claims the benefit of U.S. Provisional Application Ser. No. 60/779,207, filed Mar. 3, 2006, entitled Hybrid NH3 or Liquified Gas Delivery System, which is hereby incorporated herein by reference.

### STATEMENT REGARDING FEDERALLY SPONSORED RESEARCH OR DEVELOPMENT

Not applicable

### BACKGROUND

The semiconductor industry is today confronted with increasing needs for electronic specialty gases used in the various steps necessary for the fabrication of semiconductor devices. Electronic specialty gases include, for example, NH₃ (ammonia), HF, HCl, Cl₂, HBr, N₂O, WF₆ and BCl₃, only to name a few. These chemical gases typically liquefy at ambient temperature, and because of this fact pose difficulties in their destruction. These difficulties are directly related to their pressure and flow rate during utilization. Because semiconductor manufacturing facilities require high flow rates, pressure and temperature must be closely monitored and manipulated in the systems used to store and deliver these gases to the point of use in the manufacturing facility. In addition, purity of the chemical gases is affected by changes in temperature and pressure, and must also be monitored and maintained. The high flow rates required by many semiconductor applications necessitate liquefied delivery of these gases, as vapor supply limits the flow rate generated and the pressure maintained within the system.

The production of certain semiconductor devices, such as liquid crystal flat panel displays (LCD screens), known also as thin film transistor (TFT) screens, and LED displays, require especially high flow rates of chemical gases. For example, flow rates of approximately 500 or 1,000 L/min are required for these fabrication. More particularly, the high flow rates may also be highly variable. For example, a display fabrication plant (fab) may not require high flow rates of a chemical gas, such as ammonia, at start-up because the number of displays produced and/or the number of fabs supplied may be limited. During these initial stages, the fabrication plant is supplied by a small or moderately sized container, for example, a ton vessel typically capable of holding approximately 950 liters of ammonia. However, when fabs ramp up to full production flows (which may take, for example, one year), or multiple fabrication plants require a central supply, the flow rate will increase drastically over that required at start-up. At these higher flow rates, the ton vessels will require frequent replacement, possibly once a day. Changeouts of the ton vessels are undesirable because they require time and manpower, and increase the risk of contamination in the ammonia delivery process.

In addition to highly variable flow rates due to ramping up from start-up to full production or multi-fab flows, flow rates may vary during the gas delivery and manufacturing process. For example, flat panel display fabs may require a liquefied ammonia flow rate of 2,000 standard liters per minute (slm) for full production, and then, in a matter of seconds, may need to scale back to almost no flow.

These high and variable vapor flow rates at the point of use are pushing the limits of current gas delivery systems. It is desirable for gas delivery equipment to meet various end user requirements, such as growing the delivery equipment capacity as production of the semiconductor devices grows and supplying the fabrication process from a central location. Further, it is desirable to minimize the amount of the liquefied chemical gas near or proximate to the fab, and to deliver the chemical gas in liquid phase to the fab where vaporization occurs while maintaining the purity of the vapor phase.

### SUMMARY

In an embodiment of the invention, an apparatus for providing a chemical gas comprises a fabrication plant, a first vessels having a volume and proximate to the fabrication plant, the first vessel adapted to receive a liquefied chemical gas and to communicate a vaporized chemical gas to the fabrication plant, a source container located at a distance from the fabrication plant, the source container having a volume and adapted to communicate a liquefied chemical gas to the first vessel, and wherein the source container volume is substantially larger than the first vessel volume. Other embodiments and methods are described herein.

### BRIEF DESCRIPTION OF THE DRAWINGS

For a more detailed description of preferred embodiments of the present invention, reference will now be made to the accompanying drawings, wherein:

FIG. 1 is a schematic illustration of a system for storing, vaporizing and delivering chemical gases to an end user in accordance with an embodiment of the invention;

FIG. 2 is a schematic illustration of an alternative embodiment of the system of FIG. 1;

FIG. 3 is a schematic illustration of an alternative embodiment of the system of FIG. 1;

FIG. 4 is a schematic illustration of an alternative embodiment of the system of FIG. 1; and

FIG. 5 is a flow diagram for a process for storing and delivering chemical gases to an end user in accordance with an embodiment of the invention.

### DESCRIPTION OF PREFERRED EMBODIMENTS

Certain terms are used throughout the following description and claims to refer to particular system components. This document does not intend to distinguish between components that differ in name but not function.

In the following discussion and in the claims, the terms “including” and “comprising” are used in an open-ended fashion, and thus should be interpreted to mean “including, but not limited to . . . ” Also, the following discussion makes specific reference to ammonia when describing the various embodiments, but it should be understood that ammonia may be replaced by various other electronic specialty gases, such as the ones previously mentioned. Various components described herein are connected by or communicate through conduits or lines, and it is to be understood that the terms “conduit” or “line” may include pipes, tubes, or other means for transporting gases and their liquid phase counterparts.

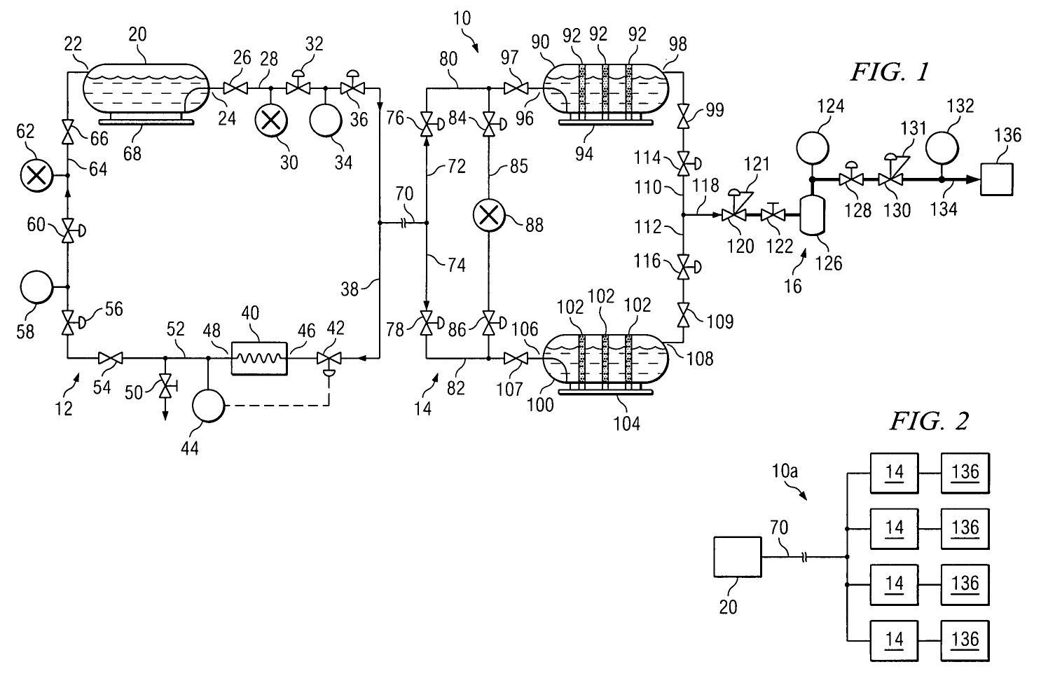

With reference to FIG. 1, a liquefied chemical gas storage, vaporization and delivery system 10 is shown having a bulk storage and pressure build portion or circuit 12, a vapor production portion or circuit 14, and a vapor delivery portion 16. Storage portion 12 further includes a source container 20, such as an iso-container, and a vaporizer 40. An iso-container holds, for example, approximately 17,000 to 20,000 liters of liquid and is constructed to contain the weight and pressure created by the liquefied chemical gas, as is known to persons of ordinary skill in the art. An iso-container volume is up to ten times greater, or more, than a ton vessel volume. Source container 20 is made of stainless steel, for example, or other suitable materials known to persons of ordinary skill in the art to be compatible with electronic specialty gases. The present invention should not be limited to the source containers described herein and persons of ordinary skill in the art will appreciate that the present invention includes source containers other than those specifically described herein.

Source container 20 includes an inlet 22 and an outlet 24, and may rest upon a scale 68. A value 26 is disposed adjacent outlet 24, and facilitates the disconnection/reconnection of source container 20 from conduit 28 or regulate the flow of fluid into conduit 28. A purge point 30 is located just downstream of value 26, and is used to perform a vacuum or pressure purge using N₂ or other appropriate purge gas during disconnection/reconnection of source container 20, as is known to persons of ordinary skill in the art. Conduit 28 leads to an array of valves 32, 36 and pressure transducer 34 for regulating and monitoring the fluid flow in conduit 28. Conduit 28 leads into a conduit 38, which connects to a value 42 adjacent vaporizer 40 having inlet 46 and outlet 48. Various vaporizers may be used with the embodiments of the present invention described herein, such as electrical or shell and tube heat exchanger type vaporizers. The present invention should not be limited to the vaporizers described herein and persons of ordinary skill in the art will appreciate that the present invention includes vaporizers other than those specifically described herein.

Outlet 48 of vaporizer 40 leads into conduit 52, which includes a pressure switch 44, a vent value 50 and a valve 54. Pressure switch 44 is connected to valve 42. Downstream of valve 54 is valve 56, pressure transducer 58, valve 60, purge point 62, conduit 64 and valve 66, which complete the storage and pressure build circuit at inlet 22 of source container 20. Alternatively, in warm or controlled climates, for example, the pressure build feature of circuit 12 (e.g., vaporizer 40) is not needed for liquid delivery from source container 20.

Still referring to FIG. 1, vapor production portion 14 is connected to portion 12 via conduit or delivery line 70. Line 70, as well as other liquid delivery lines described herein, are of a suitable size and nature to contain liquefied chemical gas, as is known to persons of ordinary skill in the art. Optimal inner diameter and external insulation assists in ensuring that the liquefied chemical gas maintains its liquid phase while being transported in line 70. Line 70 splits into two lines 72, 74 for delivery of liquefied chemical gas in two directions. Conduit 72 includes a valve 76, which has an outlet leading into conduit 80. Conduit 80 connects to a valve 97 and a conduit 85 having a valve 84, purge point 88 and valve 86. Valve 97 is adjacent inlet 96 of a ton vessel 90, with valve 97 allowing disconnection/reconnection of ton vessel 90. Ton vessel 90 sits atop a scale 94 and includes heating or vaporization elements 92, such as induction heaters. Induction heaters may be branched in parallel, and may be of the “pancake belt” type. However, the present invention should not be limited to the vaporization elements or inductors described herein and persons of ordinary skill in the art will appreciate that the present invention includes vaporization elements or inductors other than those specifically described herein. Vessel 90 includes an outlet 98 and a disconnection/reconnection valve 99 adjacent outlet 98. Just downstream of valve 99 is a valve 114 and conduit 110.

Conduit 74 leads into a similar arrangement as just described including a ton vessel 100 connected in parallel with vessel 90. Conduit 74 connects to a valve 78 and conduit 82. Conduit 82 connects to conduit 85 having the apparatus described above, and also connects to a disconnection/reconnection valve 107 adjacent an inlet 106 of ton vessel 100. Vessel 100 include inductors 102 and scale 104 similar to those previously described. An outlet 108 of vessel 100 communicates fluid to a value 109, valve 116 and a conduit 112. Conduit 112 connects to conduit 110.

Conduits 112 and 110 connect at conduit 118, which is the beginning of vapor delivery portion 16 of system 10. Conduit 118 communicates fluid to a valve 120 having a backpressure regulator 121, valve 122, buffer tank 126, pressure transducer 124, valve 128, valve 130 having pressure regulator 131 and pressure transducer 132, before conduit 134 carries the vaporized gas to a fabrication building 136 or other point of use. The individual components and operation of vapor delivery portion 16 are known to persons of ordinary skill in the art. Further, the present invention should not be limited to the vapor delivery equipment described herein and persons of ordinary skill in the art will appreciate that the present invention includes vapor delivery equipment other than that specifically described herein. For example, delivery portion 16 may be disposed immediately adjacent or proximate to fabrication building 136 or, alternatively, some or all of the delivery equipment is disposed within building 136.

Although shown as a short distance in FIG. 1, the distance that the liquid ammonia must travel between storage and pressure circuit 12 and vaporization circuit 14 through supply line 70 may be large. For example, the distance may be one or several kilometers such that storage of large quantities of ammonia is away from and not proximate to the fabrication building. The equipment associated with the bulk storage and pressure build circuit will not interfere with the operation of the fabrication plant when located at a distance from the area proximate to the fabrication building. For such long range liquid delivery lines, it is known to persons of ordinary skill in the art for the lines to have certain diameters, insulation, and other characteristics to maintain the liquid phase delivery of chemical product. While storage portion 12 is located away from fab 136, vaporization circuit 14 is located proximate to fab 136, which includes being located inside, adjacent, or on a backpad of fab 136. Likewise, delivery portion 16 is proximate to fab 136, which includes being located inside or adjacent fab 136.

Although FIG. 1 shows two ton vessels 90, 100, it is contemplated by the present invention that only one ton vessel be connected to and served by storage and pressure portion 12. As long as valve 78 remains closed while valve 76 is open, vaporization portion 14 effectively includes only one ton vessel. Alternatively, values 76 and 78 are opened simultaneously for increased vapor supply to delivery portion 16. Also, either ton vessel 90, 100 may be used as the backup vessel during changeout of the other vessel, such as to prevent disruption of the vapor supply.

Referring to FIG. 2, a further embodiment in accordance with the invention is shown. A system 10a comprises a source container 20 located some distance away from vapor production portions 14 and fabs 136. Delivery line 70 connects source container 20 to multiple vapor production portions 14 having one or more vessels, in accordance with embodiments previously described. Each vapor production portion 14 connects to a fab 136. Thus, source container 20 supplies multiple fabs 136 from a remote location. Source container 20 supplies fabs 136 via vessels located remotely relative to source container 20 and proximate to fabs 136. In a further embodiment, fabs 136 comprise multiple fabrication tools (not shown), as is known to one of ordinary skill in the art, such that the point of use tools located in a fab building are supplied by one or more vapor production vessels, which are ultimately supplied by a remotely located source container.

The operation of system 10 will now be descried, with reference to FIG. 1. Liquid phase ammonia is stored in container 20 and supplied to vaporizer 40, as outlet 24 communicates with the lower liquid portions of the stored ammonia. Vaporizer 40 vaporizes the liquid ammonia and provides the vaporized ammonia to inlet 22, which communicates with the upper vaporized portions, or head space, of the stored ammonia in container 20. This pressurizes source container 20 to a predetermined pressure, which is designed to continuously force liquid ammonia through outlet 24 and into line 70 for delivery of liquid phase ammonia to vaporization circuit 14. The predetermined pressure is 150-200 psig, for example. As previously described, vaporizer 40 may not be required to provide the predetermined pressure in source container 20.

Valve 76 is opened to supply liquid ammonia to ton vessel 90. Whether vessel 90 requires ammonia may be determined by weight measurement of vessel 90 by scale 94, or, alternatively, may be determined by level sensors such as sonic or float sensors. The present invention should not be limited to the level sensors described herein and persons of ordinary skill in the art will appreciate that the present invention includes level sensors other than those specifically described herein. Inductors 92, or other suitable heating elements, heat vessel 90 and its contents such that a continuous supply of vapor phase ammonia is produced and available for being drawn off through outlet 98.

Vaporized ammonia that exists outlet 98 enters conduit 110, which then connects to conduit 118 of delivery portion 16 of the system. Conduit 118 delivers the vapor phase ammonia to valve 120 and backpressure regulator 121. Backpressure regulator 121 is used to control upstream pressure of the liquid ammonia delivery lines and vessel 90 to avoid vaporization of ammonia in the liquid delivery lines. Downstream of the backpressure regulator 121 is a buffer tank 126 to provide a buffer capacity for the vaporized ammonia before delivery to the point of use, as is known to one having skill in the art. However, buffer tank 126 is optional due to the buffer capacity available in ton vessel 90. Operation of the other components of delivery portion 16 serves to efficiently provide vaporized ammonia, or any other chemical gas, to the point of use and is known to persons of ordinary skill in the art.

Over time, increasing quantities of heavy impurities (e.g. water, metals, and oils) tend to accumulate in the liquid phase ammonia in vessel 90. Upon sufficient accumulation of impurities in vessel 90, vessel 90 may be changed out or the contaminated ammonia may be scrubbed onsite. Detection of the impurity level in vessel 90 may be achieved by weighing the contents of vessel 90 with scale 94, or by other methods described herein or known to persons of ordinary skill in the art. The changeout and scrubbing processes are known to persons of ordinary skill in the art. If vessel 90 is changed out, valve 84 may be opened such that access to purge point 88 via conduit 85 may be had and appropriate purging achieved. During changeout, the remainder of system 10 is operable, though it may be shut down if necessary.

Operation of ton vessel 100 is similar to the operation of vessel 90 previously described. Valve 78 is opened to deliver liquid ammonia to vessel inlet 106. Heaters 102 of vessel 100 heat the liquid ammonia to provide an ample and continuous supply of vaporized ammonia to outlet 108 and vapor supply line 112. Scale 104 is used to measure the weight of vessel 100 and determine whether liquid ammonia is needed. If the vessel weight is too low, valve 78 is opened to allow liquid ammonia to enter vessel 100. Valve 86 is opened to allow access to purge point 88 during changeout of vessel 100, when N₂ or other purging may be required. An impurity level in vessel 100 that exceeds the user's specification may be addressed as previously described.

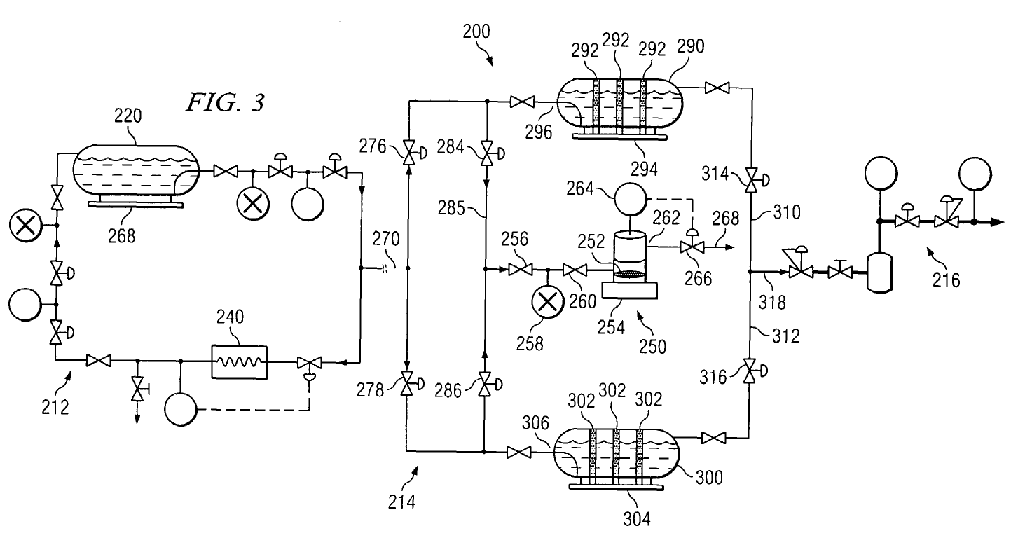

With reference to FIG. 3, an alternative embodiment of a liquefied chemical gas storage, vaporization and delivery system is shown by schematic illustration. System 200 shares certain similarities with system 10 of FIG. 1. Portion 212 is a bulk storage and pressure build circuit as previously described with respect to system 10 in FIG. 1. The parts and operation of storage and pressure portion 212 are the same as for storage and pressure portion 12, and, therefore, further description of portion 212 is unnecessary. Portion 216 is a delivery portion as previously described with respect to system 10 in FIG. 1. Thus, the parts and operation of delivery portion 216 are the same as for delivery portion 16, and further description of portion 216 is also unnecessary. However, vaporization circuit 214 differs from circuit 14 of FIG. 1.

More particularly, a liquid purge vessel 250 is connected in parallel with a ton vessel 290 if vessel 290 is the only ton vessel present or connected to the system circuit, or is connected in parallel with both ton vessels 290, 300 if two ton vessels are present and communicating with the system circuit. For purposes of the description hereinbelow, system 200 includes two ton vessels 290, 300, which communicate with the system circuit. The presence of liquid purge vessel 250 avoids the need to change out vessels 290, 300 or scrub the ammonia onsite. Vessel 250 is similarly constructed as vessels previously described such that it receives, stores, and releases liquid and vapor phase chemical gases.

Liquid purge vessel 250 is connected to conduit 285, thereby allowing fluid communication with valves 284, 286 and, in turn, inlets 296, 306 of vessels 290, 300, respectively. It is necessary for liquid purge vessel to communicate with inlets 296, 306 because inlets 296, 306 communicate with the liquid ammonia portions of vessels 290, 300. Liquid purge vessel 250 includes a scale 254, a heating element 252, and a purge connection made up of valves 256, 260 and purge point 258. Purge vessel 250 further includes an outlet 262, a valve 266, and exhaust line 268, and a pressure switch 264 connected to valve 266 and vessel 250.

During operation of system 200, it may be determined that sufficient accumulation of impurities has occurred in vessels 290, 300, and the vessels must be purged. Determination of the need to purge liquid ammonia from either or both of the ton vessels 290, 300 may be based on the initial impurity level in source container 220 and either (1) the weight change in one or both ton vessels 290, 300, determined from scale 254, indicating how much ammonia vapor has been delivered from the vessel or vessels, or (2) the changeout of source container 220. However, persons of ordinary skill in the art will appreciate that the present invention includes processes for determining the need for liquid purge other than those specifically described herein. Upon a determination that liquid purge of vessels 290, 300 is needed, liquid ammonia is directed to purge vessel 250 by opening valves 284, 286. Liquid ammonia collects in purge vessel 250 to a level where disposal is necessary. Disposal of the liquid ammonia in purge vessel 250 having concentrated impurities may be achieved by disconnecting vessel 250 at valves 260, 266 and returning vessel 250 to the supplier for treatment of waste ammonia. During disconnection, and N₂ or other appropriate purge may be achieved at purge point 258. Alternatively, waste ammonia is disposed through outlet 262 by opening valve 266 and exhausting the waste ammonia through line 268 to some form of abatement, for example, a scrubber (not shown). During liquid purge, the remainder of system 200 is operable, but may be shut down if necessary.

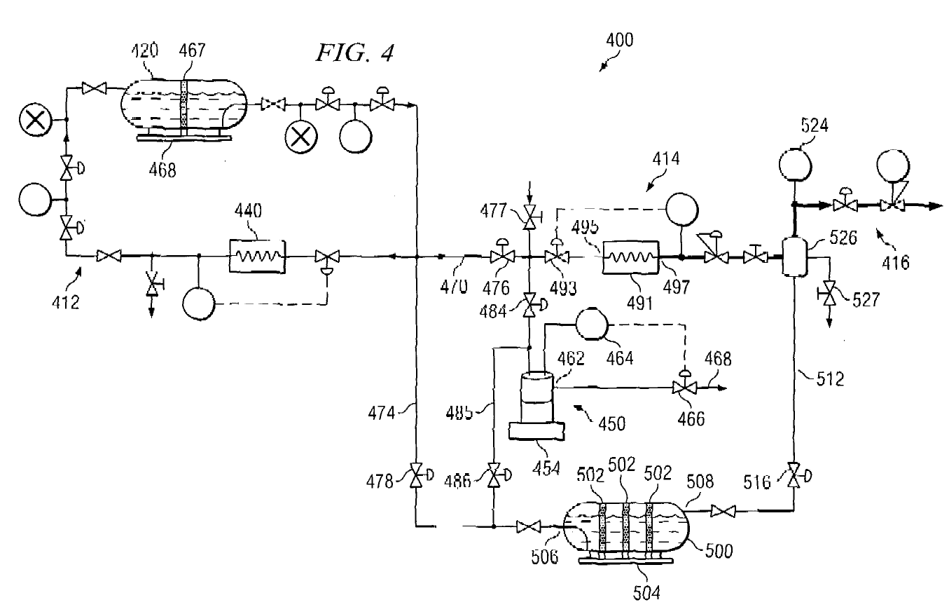

In yet another alternative embodiment, a storage, vaporization and delivery system 400 is shown schematically in FIG. 4. System 400 shares certain similarities with systems 10, 200 of FIGS. 1 and 2, respectively. Portion 412 is a bulk storage and pressure build circuit as previously described with respect to system 10 in FIG. 1. The parts and operation of storage and pressure portion 412 are the same as for storage and pressure portion 12, and, therefore, further description of portion 412 is unnecessary (with the exception that source container 420, alternatively, shows a heating element 467). Portion 416 is a delivery portion as previously described with respect to system 10 in FIG. 1. The parts of delivery portion 416 are the same as for delivery portion 16; however, the operation of delivery portion 416 differs slightly from portion 16 and will be described in more detail below. Furthermore, vaporization portion 414 differs from portion 14 of FIG. 1, and will also be described more fully below.

In system 400, liquid delivery line 470 separates storage and pressure build circuit 412 from vaporization circuit 414 a significant distance, as previously described. Storage and pressure build circuit 412 is connected to a vaporizer 491. A valve 476 is opened to deliver liquid ammonia to a valve 493 and inlet 495 of vaporizer 491. A valve 477 provides and N₂ purge point. After the liquid ammonia has been vaporized, vaporizer outlet 497 directs the vapor phase product to delivery portion 416.

Connected in parallel with vaporizer 491 is a liquid purge vessel 450. When it is determined that liquid purge of vaporizer 491 is needed to purge liquid and possible residues from liquid input 495, using determination methods such as those previously described, valve 484 is opened. Liquid ammonia is communicated to purge vessel 450. Scale 454 helps determine if waste ammonia in purge vessel 450 is to be disposed of, as previously described, and disposal may be achieved by disconnection and treatment of purge vessel 450 or evacuation of vessel 450 via outlet 462, valve 466, and exhaust line 468 to a scrubber (not shown).

System 400 further adds a ton vessel 500 (or, several ton vessels) connected in parallel with vaporizer 491. The operation of ton vessel 500 is similar to what has been previously described. Liquid supply line 474 and valve 478 direct liquid ammonia to inlet 506 of ton vessel 500. Valve 486 is opened to line 485 for liquid purge of vessel 500. Heating elements 502 vaporize the liquid phase ammonia, and vapor phase ammonia is drawn from outlet 508 into exit line 512. Line 512 delivers the vapor phase ammonia to buffer tank 526.

Systems 200, 400 include further embodiments similar to system 10a of FIG. 2, wherein the source containers supply multiple vapor production vessels, which then supply multiple fabs that may have multiple fabrication tools. As previously descried, the source containers are located away from the collection of proximately located vapor production vessels, delivery equipment, and fab buildings.

All of the system 10, 200, 400 further include certain parts, such as pressure sensors, pressure switches, temperature sensors, and valves, that are important to the systems but which were not specifically described because their use and operation are well known to persons of ordinary skill in the art. Furthermore, the valves shown and described herein may be check valves, solenoid valves, three-way valves or any other various valves known to persons of ordinary skill in the art. The present invention should not be limited to the valves described herein and persons of ordinary skill in the art will appreciate that the present invention includes valves other than those specifically described herein. Furthermore, the overall control system is not shown or specifically described herein, as any suitable control system known to persons of ordinary skill in the art may be used in conjunction with the embodiments described herein. For example, a central control system, such as a programmable logic controller (PLC), may be used to operate the various devices in systems 10, 200, 400.

The systems 10, 200, 400 described herein have many uses, but they are especially useful when a potentially high flow fabrication plant, such as those for liquid crystal flat panel displays, have a momentary or short-period low-flow requirement. For example, during initial phases of fab operation, only low flow of ammonia is required. Thus, a ton vessel (having a modest liquid supply) may adequately service the end user. The source container circuits 12, 212, 412 are connected to vaporization circuits 14, 214, 414, respectively, having the ton vessels, via extended supply lines 70, 270, 470. However, the source container circuits 12, 212, 412 may simply not be communicating with vaporization circuits 14, 214, 414 because valves 76, 276, 476, respectively, are closed. Alternatively, source container circuits 12, 212, 412 are disconnected from vaporization circuits 14, 214, 414, but readily available for connection when flow requirements increase. In yet another use of the systems, the source contained circuits are brought in and connected to the remainder of the system long after the fab has been operating, such as when a fab has been ramping up to full production for a year or more. In this case, the user may install the vaporization and delivery portions of the system, saving the cost of storage and pressure build circuit installation until much later.

When end user flow requirements increase, it is necessary for the source container circuits 12, 212, 412 to supplement the vaporization circuits 14, 212, 414 with liquid flow of ammonia. With system 10 of FIG. 1, source container circuit 12 (having a significantly large liquid supply relative to a ton vessel, such as ten times larger) is in series with vaporization circuit 14 having one or more ton vessels, thereby providing the delivery of liquid ammonia needed for the vaporization process of a high flow and user. The various ton vessels are then used as a backup supply of liquid ammonia. System 200 includes a similar arrangement to that of system 10, with the further addition of the liquid purge vessel apparatus. The liquid purge vessel 450 operates to purge liquid ammonia and collect the contaminated product to be disposed of, thereby maintaining the purity of the vapor phase product being delivered from the ton vessels. System 400 includes a variation on the arrangements of systems 10, 200, while maintaining the flow requirement flexibility characteristic. System 400 includes an arrangement of a source container circuit 412 providing liquid ammonia to a vaporizer 491. System 400 further includes the liquid purge vessel 450 and ton vessel 500 connected in parallel with vaporizer 491. Ton vessel 500, which is connected in parallel with other ton vessels, provides a backup system to the source container and is also liquid-purged via purge vessel 450. Furthermore, ton vessel 500 may be implemented at fab start-up with just the vapor delivery lines of vessel 500 used to supply ammonia to the end user, thereby eliminating the need for liquid delivery of ammonia until the flow requirements increase to the point where liquid flow is needed alone with a larger source vessel.

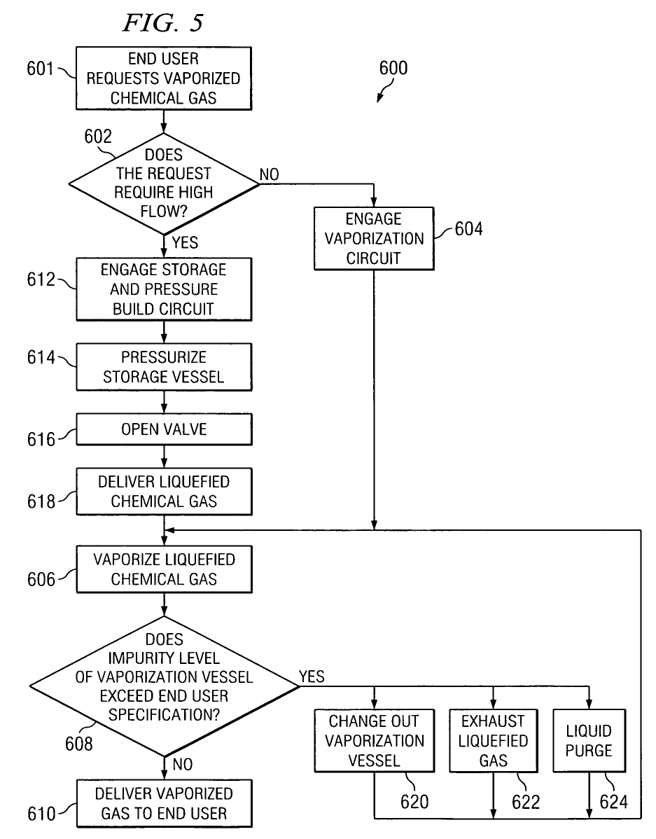

With reference to FIG. 5, a flow diagram is shown representing a process 600 to which the various embodiments described herein are directed. As has been described, the end user demand starts process 600. Accordingly, a request for vaporized chemical gas is made by the end user, shown as box 601. At 602, a determination of whether the request requires high flow is made. If the answer is “no” (i e, low-flow requirement), then the vaporization circuit is engaged at box 604. The liquefied chemical gas is vaporized at 606. Referring back to box 602, if the answer is “yes,” and a high flow is required, then the process engages the storage and pressure build circuit at 612. Next, the storage vessel or source container is pressurized at 614, a valve is opened at 616, and the liquefied chemical gas is delivered at 618. Box 618 is rejoined to the main process at box 606 so that the liquefied chemical gas of the source container is vaporized.

After vaporization at 606, another determination is made at 608—does the impurity level of the vaporization vessel exceed the end user's specification? If “no,” then the vaporized chemical product is delivered to the end user at 610. If “yes,” either the vaporization vessel is changed out at 620, the liquefied gas is exhausted to a scrubber or other form of abatement at 622, or liquid purge is engaged at 624. After any one of a combination of boxes 620, 622, 624 is performed, vaporization at 606 continues.

The above discussion is meant to be illustrative of the principles and various embodiments of the present invention. While the preferred embodiment of the invention and its method of use have been shown and described, modifications thereof can be made by one skilled in the art without departing from the teachings of the invention. The embodiments described herein are exemplary only, and are not limiting. Many variations and modifications of the invention and apparatus and methods disclosed herein are possible and are within the scope of the invention. Accordingly, the scope of protection is not limited by the description set out above, but is only limited by the claims which follow, that scope including all equivalents of the subject matter of the claims.

What is claimed is:

1. An apparatus for providing a chemical gas comprising:
a fabrication plant;
a first vessel having a volume and proximate to the fabrication plant, the first vessel adapted to receive a liquefied chemical gas and to communicate a vaporized chemical gas to the fabrication plant;
a source container located at a distance from the fabrication plant, the source container having a volume and adapted to communicate a liquefied chemical gas to the first vessel; and
wherein the source container volume is substantially larger than the first vessel volume.

2. The apparatus of claim 1 wherein the source container volume is at least ten times larger than the first vessel volume.

3. The apparatus of claim 1 wherein the source container volume is approximately 17,000 liters and the first vessel volume is approximately 950 liters.

4. The apparatus of claim 1 wherein the source container is located at least 1 kilometer from the fabrication plant.

5. The apparatus of claim 1 wherein the fabrication plant, the first vessel, and the source container are connected in series.

6. The apparatus of claim 1 further comprising a vaporizer adapted to pressurize the source container and provide a substantially liquefied delivery of gas to the first vessel.

7. The apparatus of claim 1 further comprising a second vessel in parallel fluid communication with the first vessel, the second vessel having a volume and adapted to receive a liquefied chemical gas from the source container and to communicate a vaporized chemical gas to the fabrication plant, and wherein the second vessel volume is substantially smaller than the source container volume.

8. The apparatus of claim 1 further comprising a liquid purge vessel in parallel fluid communication with the first vessel.

9. The apparatus of claim 1 further comprising a vaporizer in parallel fluid communication with the first vessel.

10. The apparatus of claim 1 further comprising a buffer tank disposed in the fabrication plant and adapted to receive the vaporized chemical gas from the first vessel.

11. The apparatus of claim 1 further comprising:
a plurality of vessels adapted to receive the liquefied chemical gas from the source container; and
a plurality of fabrication plants, wherein each vessel is located proximate to one of the fabrication plants.

12. The apparatus of claim 11 further comprising:
a plurality of fabrication tools located within each of the fabrication plants.

13. An apparatus for providing a chemical gas comprising:
a fabrication plant;
a source container circuit having a source container and a vaporizer;
a vaporization circuit proximate to the fabrication plant and having at least two vessels connected in parallel, each of the vessels having means for delivering a chemical gas to the fabrication plant; and
a supply line adapted to communicate a substantially liquid phase chemical gas between the source container circuit and the vaporization circuit, the supply line adapted to connect the source container at a significant distance from the fabrication plant.

14. The apparatus of claim 13 wherein the vaporization circuit further comprise means for selectively collecting a contaminated liquid phase chemical gas.

15. The apparatus of claim 13 further comprising means for selectively delivering the chemical gas from only one of the at least two vessels.

16. An apparatus for providing a chemical gas comprising:
a fabrication plant;
a source container circuit having a source container and a vaporizer;
a vaporization circuit proximate to the fabrication plant and having a ton vessel connected in parallel with a second vaporizer, the ton vessel and the second vaporizer both having means for delivering a chemical gas to the fabrication plant; and
a supply line adapted to communicate a substantially liquid phase chemical gas between the source container circuit and the vaporization circuit, the supply line adapted to connect the source container at a significant distance from the fabrication plant.

17. The apparatus of claim 16 wherein the vaporization circuit further comprise means for selectively collecting a contaminated liquid phase chemical gas.

18. A method of providing a chemical gas comprising:
storing a first volume of liquefied chemical gas in a first vessel adjacent a fabrication plant;
vaporizing a portion of the first volume of liquefied chemical gas in response to an end user demand;
providing a source container having a volume significantly larger than the first vessel volume;
delivering a liquid phase chemical gas from the source container to the first vessel at a significant distance from the fabrication plant in response to an increased end user demand; and
increasing the vaporization rate of the first volume of liquefied chemical gas.

19. The method of claim 18 further comprising:
purging the first volume of liquefied chemical gas of a contaminated liquid; and
disposing of the contaminated liquid.

20. The method of claim 18 further comprising:
providing a second vessel in parallel with the first vessel; and
selectively delivering the liquid phase chemical gas from the source container to the second vessel.

21. The method of claim 18 further comprising:
delivering the liquid phase chemical gas from the source container to a plurality of vessels; and
delivering the vaporized chemical gas from the plurality of vessels to a plurality of fabrication plants, each fabrication plant having a plurality of fabrication tools.
